(19) United States
(12) Patent Application Publication
(10) Pub. No.: US 2025/0159743 A1
(43) Pub. Date: May 15, 2025

(54) Communication System

(71) Applicant: ATME Inc., Frederick, MD (US)

(72) Inventors: Joseph Ogundeyi, Frederick, MD (US); Jose Perez, Adelphi, MD (US)

(73) Assignee: ATME Inc., Frederick, MD (US)

(21) Appl. No.: 18/945,739

(22) Filed: Nov. 13, 2024

Related U.S. Application Data
(60) Provisional application No. 63/598,173, filed on Nov. 13, 2023.
(60) Provisional application No. 63/644,299, filed on May 8, 2024.

(51) Int. Cl. H04W 76/14; H04W 4/46

(52) U.S. Cl. CPC H04W 76/14; H04W 4/46

(57) ABSTRACT

A communication system includes a network communication interface to communicate over at least one network with a first computing device, and a second computing device, one or more processors, and one or more memory resources storing instructions executable by the one or more processors. The instructions cause the communication system to receive, over the one or more networks, location data from each of the first and second computing devices, transmit, over the at least one network, a position signal to the computing device of the first computing device, the position signal causing the first computing device to display a position of the second computing device on a graphical user interface (GUI) generated by an application executing on the first computing device, and transmit, over the at least one network, a message from the first computing device to the second computing device.

### CROSS-REFERENCE TO RELATED APPLICATIONS

This application claims the benefit of U.S. Provisional Patent Application No. 63/598,173 filed Nov. 13, 2023 entitled “Communication System”, and U.S. Provisional Patent Application No. 63/644,299 filed May 8, 2024 entitled “Communication System”, each of which is incorporated by reference herein in its entirety.

### BACKGROUND OF THE INVENTION

The present invention generally relates to a communication system and, more particularly, to a communication system that allows communication between vehicles that are located within geographical proximity to each other. Some communication systems allow a first user to send a message to a second user. However, such systems generally require the first user to identify the second user, either through a phone number or username, before sending a message to the second user. Therefore, what is desired is a communication system that allows a user to send a message to another user without identifying information for the second user.

### BRIEF SUMMARY OF THE INVENTION

In one embodiment, a communication system can includes a network communication interface to communicate over at least one network with a computing device of a first vehicle, and a computing device of a second vehicle, one or more processors, and one or more memory resources storing instructions that, when executed by the one or more processors, cause the communication system to receive, over the one or more networks, location data from each of the first vehicle and the second vehicle, transmit, over the at least one network, a position signal to the computing device of the first vehicle, the position signal causing the computing device of the first vehicle to display a position of the second vehicle on a graphical user interface (GUI) generated by an application executing on the computing device of the first vehicle, and transmit, over the at least one network, a message from the computing device of the first vehicle to the computing device of the second vehicle.

In some examples, the executed instructions further cause the communication system to determine if the position of the first vehicle relative to the second vehicle is below a predetermined threshold based, at least in part, on the position data of the first and second vehicles.

In some examples, the executed instructions further cause the communication system to transmit, over the at least one network, a vehicle information signal to the computing device of the first vehicle, the vehicle information signal causing the computing device of the first vehicle to display vehicle information about the second vehicle on the GUI of the computing device of the first vehicle. The vehicle information can at least one of a make, a model, and a color of the second vehicle. The vehicle information can include an image of the second vehicle.

The vehicle information can include an image of a driver of the second vehicle. The executed instructions can cause the communication system to display, on the GUI of the computing device of the first vehicle, a map including a road on which the first vehicle is located. The road can include a plurality of lanes and the map can display the plurality of lanes. The second vehicle can be one of a plurality of second vehicles. A first one of the plurality of second vehicles and the first vehicle can be located in a first one of the plurality of lanes, and a second one of the plurality of second vehicles can be in a second one of the plurality of lanes different from the first one of the plurality of lanes. The executed instructions can further cause the communication system to transmit, over the at least one network, a message from the computing device of the first vehicle to a computing device of each of the first and second ones of the plurality of second vehicles in response to selection of a burst message on the computing device of the first vehicle.

The executed instructions can cause the communication system to transmit, over the at least one network, a message from the computing device of the first vehicle to the computing device of the first one of the plurality second vehicles in response to selection of a lane message on the computing device of the first vehicle. The executed instructions can further cause the communication system to provide, on the GUI on the computing device of the first vehicle, at least one messaging icon and receive a user selection of one of the at least one messaging icons. The at least one messaging icon can include a first icon for sending a voice message. The at least one messaging icon can include a second icon for sending a text message.

The executed instructions can further cause the communication system to convert the voice message to a text message. The at least one icon can include a first appearance before the message is sent and a second appearance after the message is sent, the second appearance different from the first appearance.

The executed instructions can cause the communication system to analyze the text message, compare the text message to a database of deliverable messages and select one of the deliverable messages from the database, and transmit, over the at least one network, the deliverable message from the database to the computing device of the second vehicle.

The second vehicle can include a first one of a plurality of second vehicles and the executed instructions further cause the communication system to receive, over the one or more networks, location data of a second one of the plurality of second vehicles, determine the position of the second one of the plurality of second vehicles relative to the first vehicle, and transmit, over the at least one network, a second position signal to the computing device of the first vehicle, the second position signal causing the computing device of the first vehicle to display a position of the second one of the plurality of second vehicles on the GUI.

The executed instructions further cause the communication system to transmit, over the at least one network, a second vehicle information signal to the computing device of the first vehicle, the second vehicle information signal causing the computing device of the first vehicle to display vehicle information about the second one of the plurality of second vehicles on the GUI. The GUI can simultaneously display the vehicle information of the first and second ones of the plurality of second vehicles.

The executed instructions can further cause the communication system to access, over the at least one network, a database that includes vehicle registration and insurance information for the first vehicle. A user can select whether to receive messages in real time while they are driving or if the messages are to be saved for a later time. The system can include a user authentication mechanism to ensure that only authorized drivers can send and receive messages over the at least one network. The system can facilitate communication between vehicles.

In one embodiment, an apparatus can include at least one processor and at least one non-transitory memory including computer program code instructions, the computer program code instructions configured to, when executed, cause the apparatus to capture and store relevant information related to a vehicle parking violation observed by a user, the relevant information transmitted via a mobile application interface on the user's device, transmit the captured information to a server for processing and validation, and generate a notification to the relevant authorities or designated personnel responsible for enforcing parking regulations based on the received information.

The computer program code instructions can be further configured to, when executed, cause the apparatus to provide feedback to the user regarding the status of the reported violation. The relevant information can include a license plate number of a vehicle. The relevant information can include location data of the vehicle. The relevant information can include a make and model of the vehicle. The user can be a first user and the computer program code instructions can be further configured to, when executed, cause the apparatus to store a second user's vehicle information within the at least one non-transitory memory. The computer program code instructions can be further configured to, when executed, cause the apparatus to determine if the second user's vehicle is the vehicle committing a parking violation reported by the first user.

The computer program code instructions can be further configured to, when executed, cause the apparatus to transmit a notification to the second user regarding the vehicle parking violation. The notification can be transmitted to the second user prior to generating a notification to the relevant authorities. The computer program code instructions can be further configured to, when executed, cause the apparatus to determine a fine or fee for the parking violation. The computer program code instructions can be further configured to, when executed, cause the apparatus to determine the party to whom the fine or fee should be paid. The computer program code instructions can be further configured to, when executed, cause the apparatus to receive payment information from the second user and transfer payment from the second user to the party.

The computer program code instructions can be further configured to, when executed, cause the apparatus to access a department of motor vehicles database so as to determine information about the second user's vehicle. The computer program code instructions can be further configured to, when executed, cause the apparatus to access a department of motor vehicles database so as to determine the fee or fine for the parking violation. The computer program code instructions can be further configured to, when executed, send a request to a second apparatus for the vehicle to be towed.

An application for reporting vehicle violations can include a user interface enabling users to input details of observed parking violations, including location, time, type of violation, and photographic evidence, a data storage module for storing reported parking violation information securely, a communication module for transmitting the reported violation information to a central server for further processing, a validation module for verifying the authenticity and accuracy of the reported violations, an alert system for notifying relevant authorities or enforcement agencies about verified parking violations, and a feedback mechanism for updating users on the resolution status of reported violations.

A computer-readable storage medium storing instructions for reporting parking violations such that the instructions can include code for receiving input from users regarding observed parking violations, code for capturing and storing relevant information about the reported violations, including location coordinates, timestamp, and multimedia evidence, code for encrypting and securely transmitting the reported violation data to a remote server, code for analyzing the reported data to detect patterns or trends in parking violations, code for generating automated alerts or notifications to designated authorities or enforcement personnel based on the analyzed data, and code for providing users with real-time feedback on the status and resolution of reported violations.

### BRIEF DESCRIPTION OF THE SEVERAL VIEWS OF THE DRAWINGS

The foregoing summary, as well as the following detailed description of embodiments of the communication system, will be better understood when read in conjunction with the appended drawings of an exemplary embodiment. It should be understood, however, that the invention is not limited to the precise arrangements and instrumentalities shown.

In the drawings:

FIG. 1 is a block diagram illustrating an example communication system in accordance with an exemplary embodiment of the present invention;

FIG. 2 is a flow chart illustrating an example method of facilitating communication between a first device and a second device;

FIG. 3 is an example screenshot illustrating a user device executing a designated user application in accordance with another exemplary embodiment of the present invention;

FIG. 4 is an example screenshot illustrating a user device executing a designated user application in accordance with another exemplary embodiment of the present invention;

FIG. 5 is an example screenshot illustrating a user device executing a designated user application in accordance with another exemplary embodiment of the present invention;

FIG. 6 is an example screenshot illustrating a user device executing a designated user application in accordance with another exemplary embodiment of the present invention;

FIG. 7 is an example screenshot illustrating a user device executing a designated user application in accordance with another exemplary embodiment of the present invention;

FIG. 8 is a block diagram illustrating a computer system upon which examples described herein may be implemented;

FIG. 9 is a flow chart illustrating an example method of facilitating communication between a first device and the communication system;

FIG. 10 is an example screenshot illustrating a user device executing a designated user application in accordance with another exemplary embodiment of the present invention;

FIG. 11 is an example screenshot illustrating a user device executing a designated user application in accordance with another exemplary embodiment of the present invention;

FIG. 12 is an example screenshot illustrating a user device executing a designated user application in accordance with another exemplary embodiment of the present invention;

FIG. 13 is an example screenshot illustrating a user device executing a designated user application in accordance with another exemplary embodiment of the present invention; and

FIG. 14 is an example screenshot illustrating a user device executing a designated user application in accordance with another exemplary embodiment of the present invention

### DETAILED DESCRIPTION OF THE INVENTION

In some examples described herein, a communication system is provided to facilitate communication between a first device in a first vehicle and a second devices in a second vehicle. In accordance with examples described herein, the communication system can receive, over one or more networks, location data from each of the first and second devices. The location of the first and second devices can be representative of the location of the first and second vehicles. The communication system can determine whether a vehicle distance between the first and second vehicles is less than a threshold distance. The communication system can allow communication between the first and second devices if the vehicle distance is less than the threshold distance. Each of the first and second devices can run a designated application in communication with the communication system so as to send and receive messages. The messages can be text messages or voice messages.

In some examples, the communication system can initiate a display the locations of the first and second vehicles relative to each other on a graphical user interface (GUI) of the first and second devices. The first and second vehicles may be represented by an image of a vehicle on the GUI of the first device. The second vehicle may be represented by an identifying characteristic such as a license plate number, make and model of the vehicle, or other identifying information. The communication system can store vehicle information about the vehicle such as the license plate number, make and model of the vehicle, after market vehicle modifications, or other identifying information.

The communication system can initiate a display of a map with the locations of the first and second devices displayed on the map. The map can include an image of a road or other thoroughfare on which the first vehicle is travelling. The map can include a display of each lane of the road. The communication system can indicate which lane each of the first and second vehicles are travelling in. The communication system can allow the first device to send a message to any user devices that are located in the same lane as the first device, travelling in the same direction as the first device, or to all users on the road.

A computing device, as used herein, refers to devices including desktop computers, cellular devices, smartphones, personal digital assistants (PDAs), laptop computers, tablet devices, television (IP Television), smart watches, etc., that can provide connectivity to a network and processing resources for communicating with the system over the network. A computing device can also refer to in-vehicle devices, on-board computers, custom hardware, etc. The computing device can implement a designated application configured to communicate with the network service.

Described herein are methods, techniques, and actions performed by a computing device programmatically, or as a computer-implemented method. As used herein, programmatically means through the use of computer-executable instructions or code. The computing device can include one or more memory resources that stores the instructions or code. Some of the programmatically performed steps may be automatically performed.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

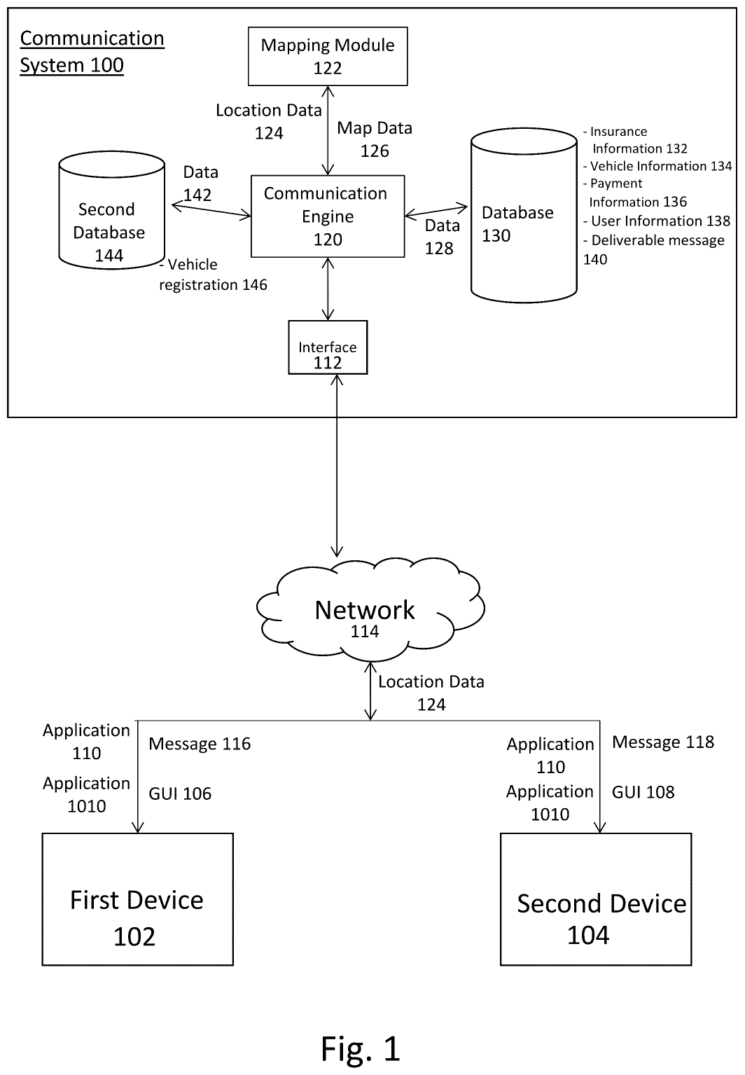

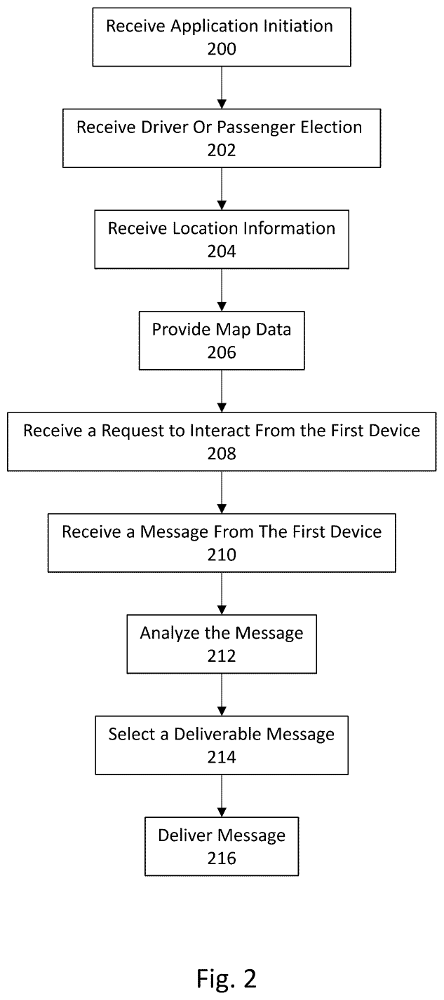

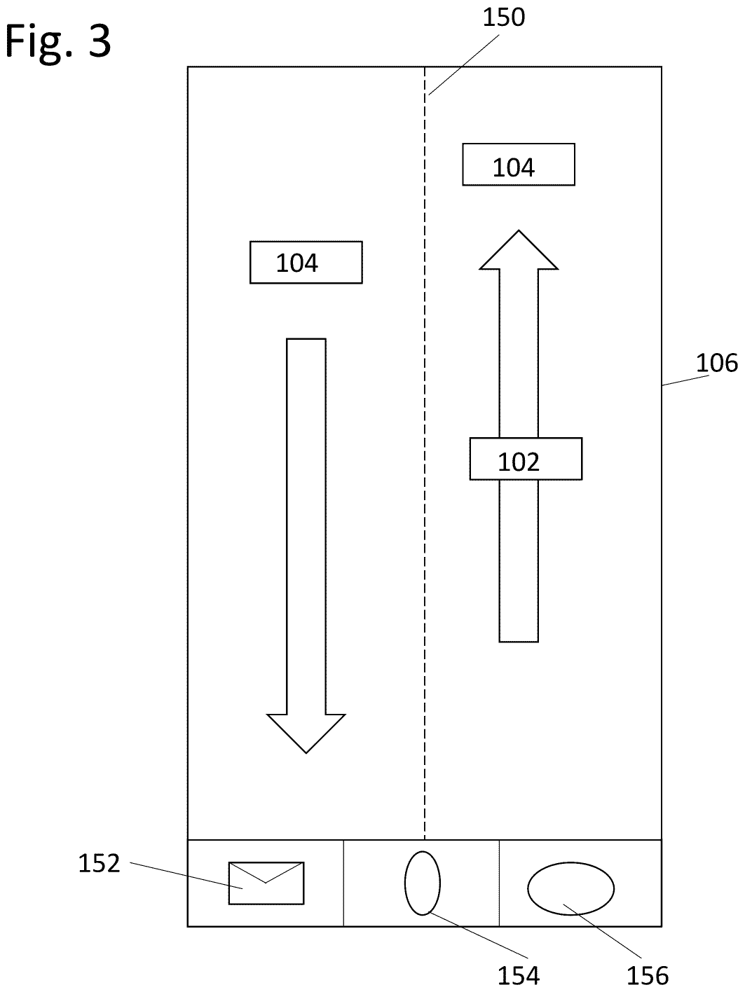

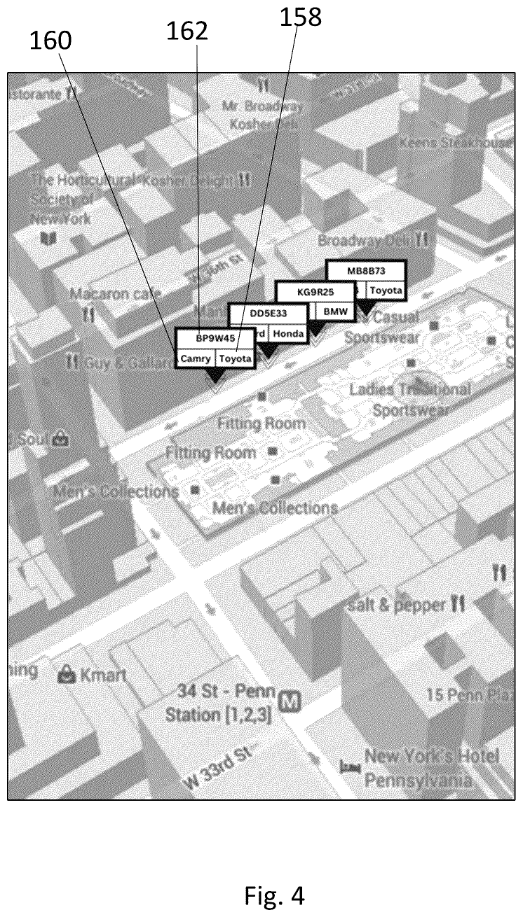

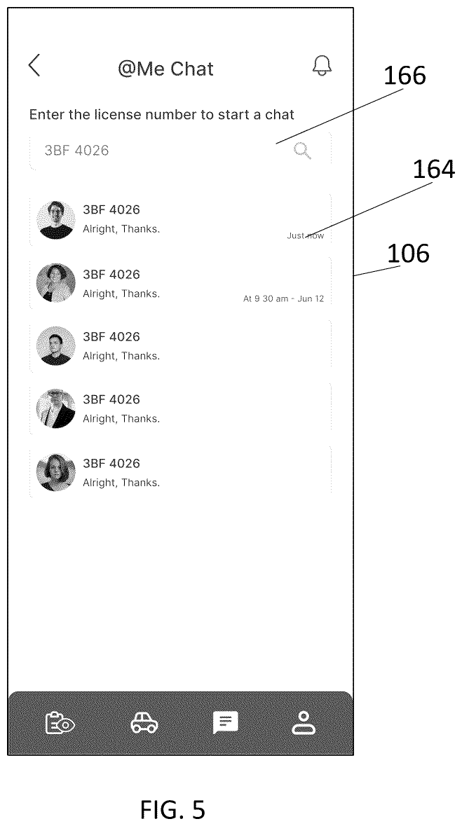

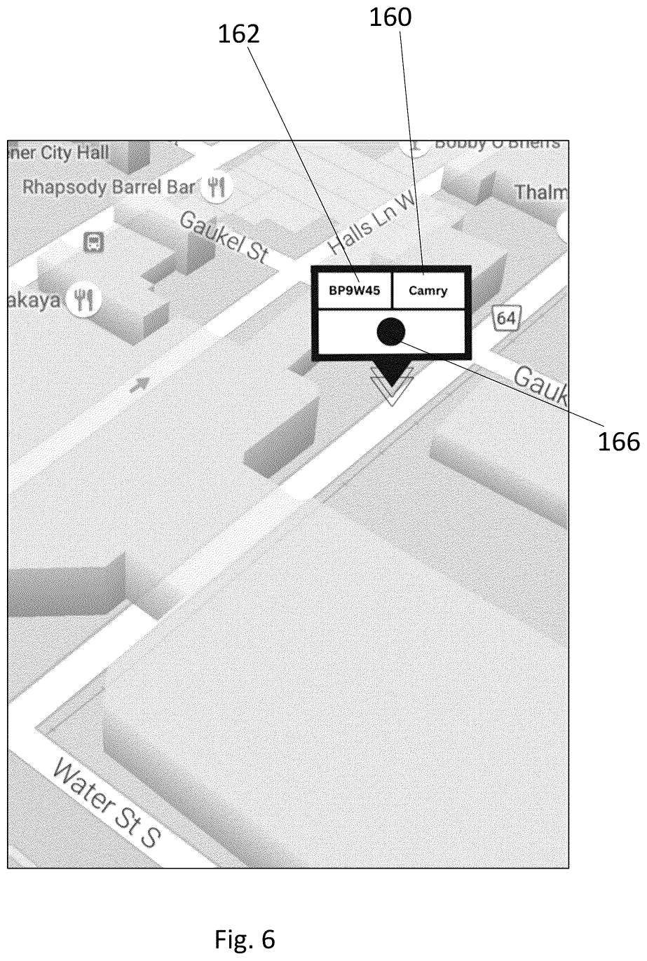

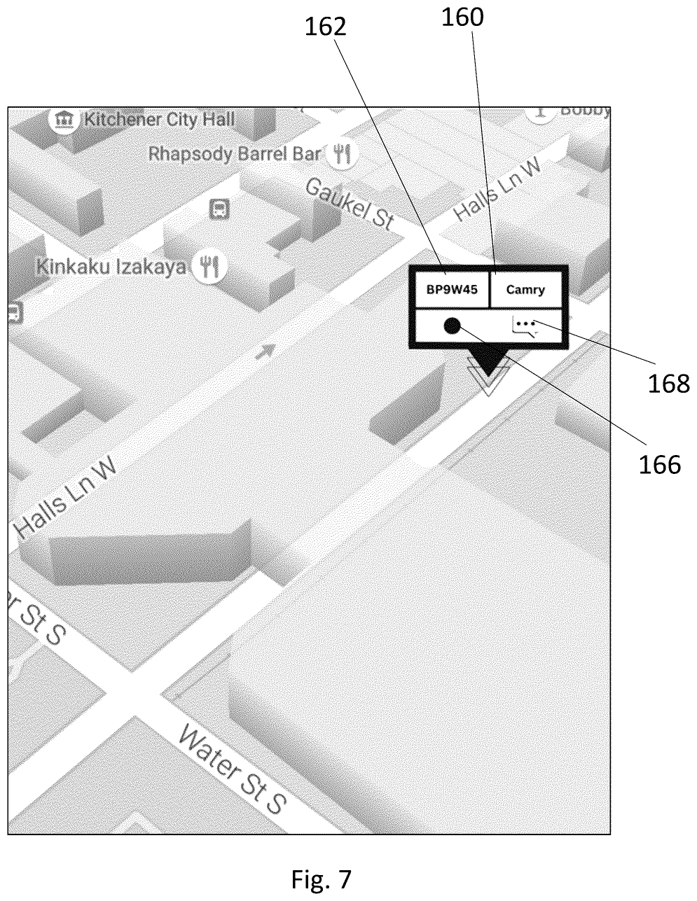

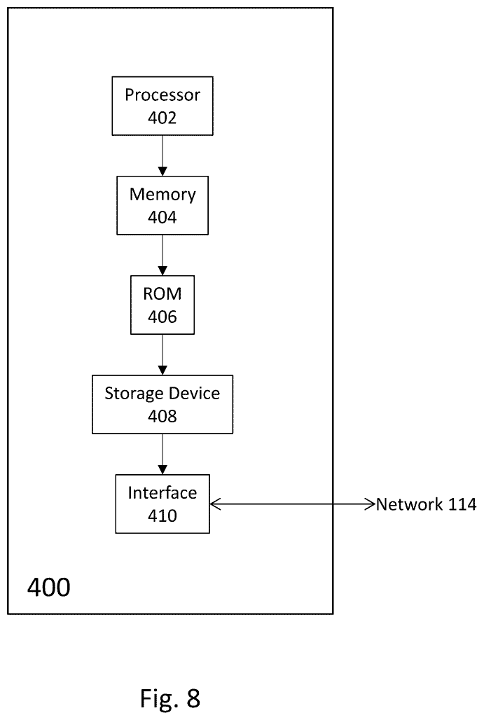

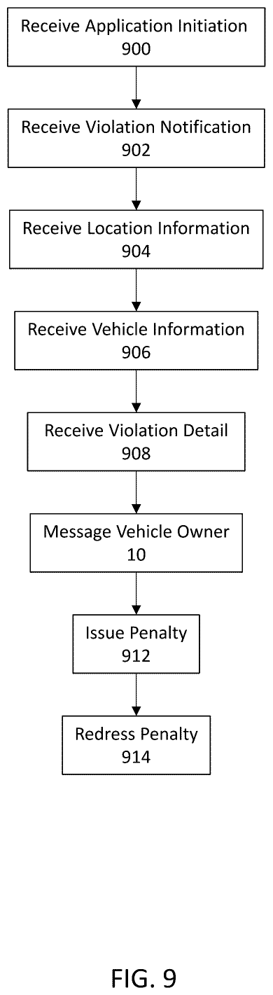

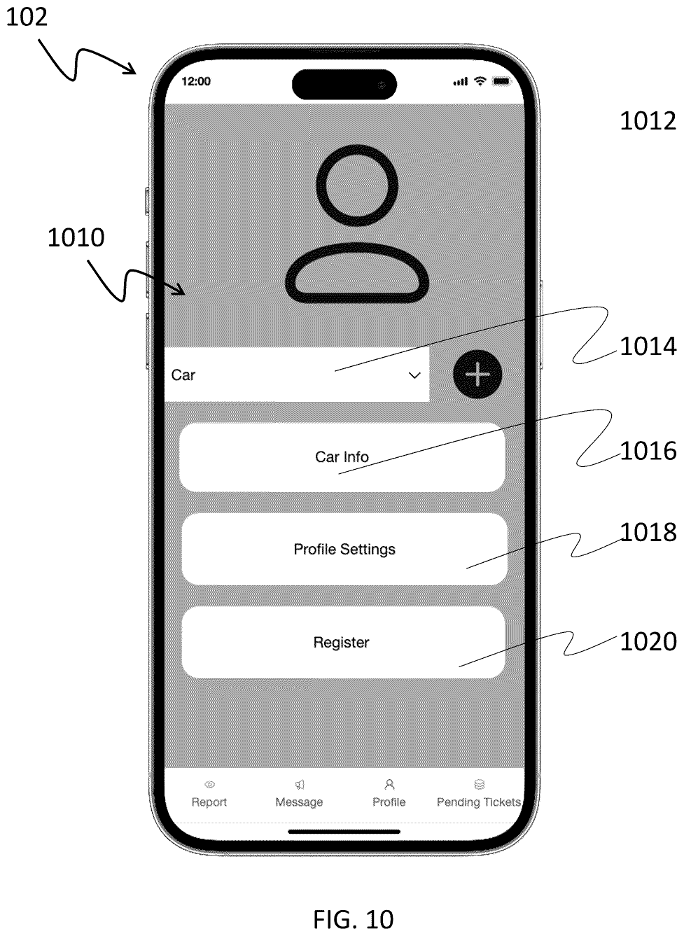

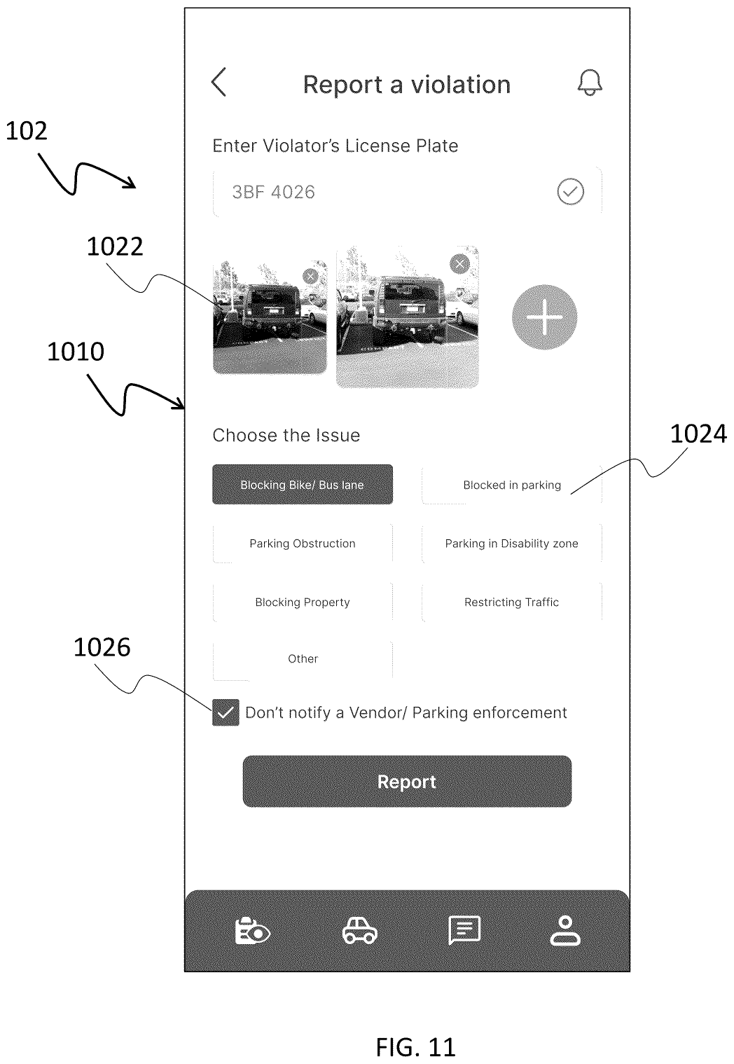

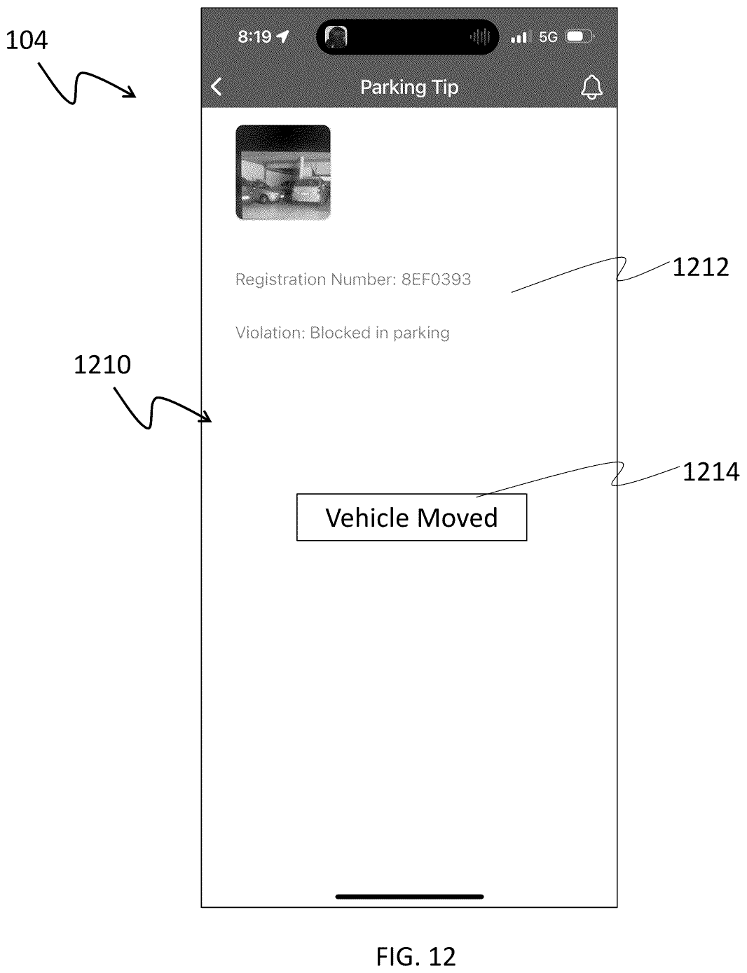

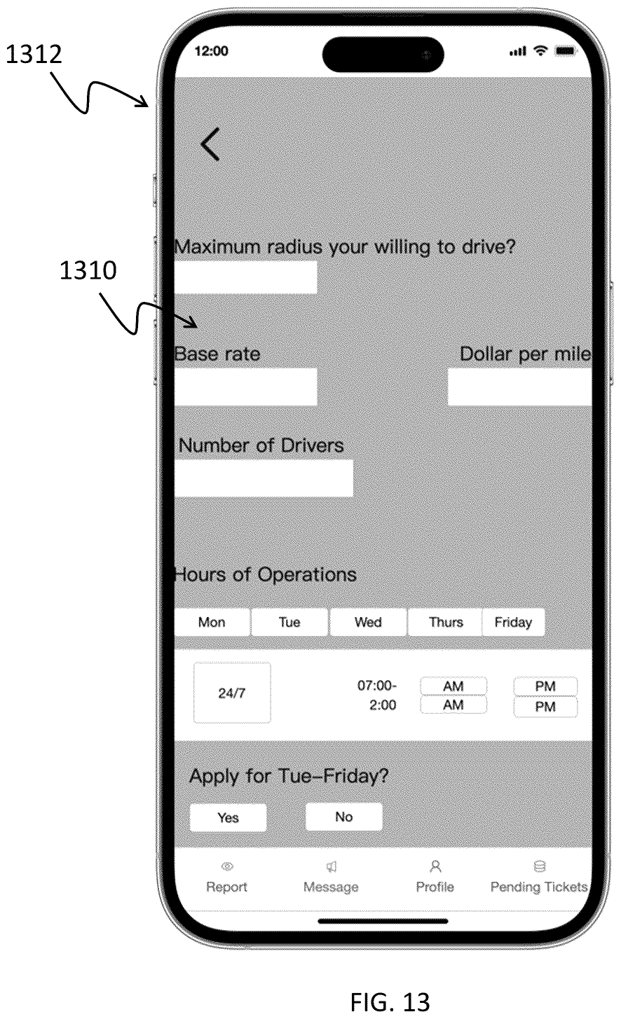

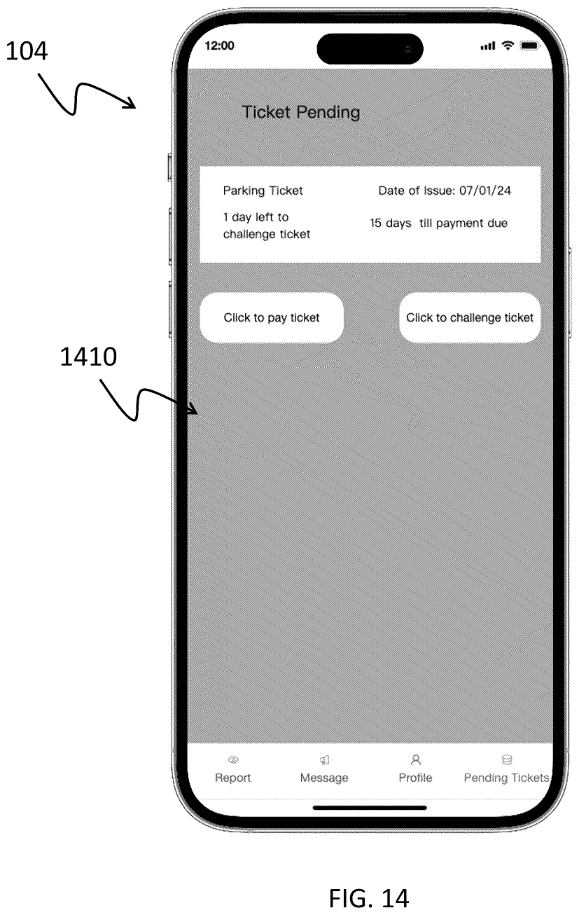

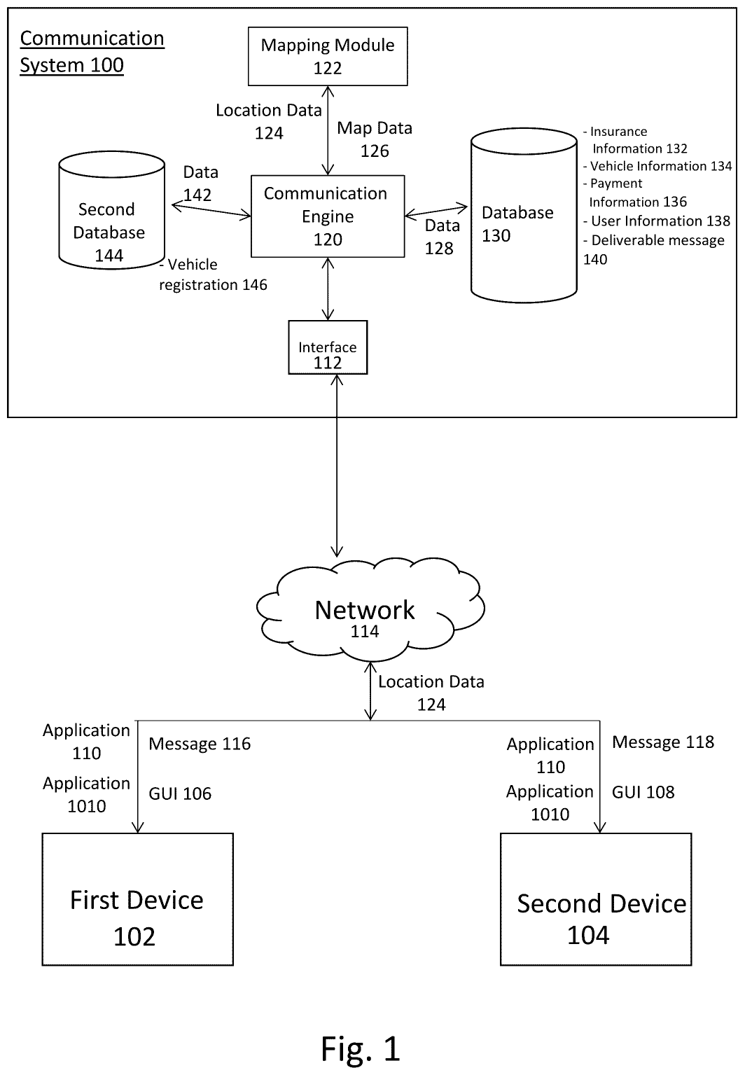

Referring to the drawings in detail, wherein like reference numerals indicate like elements throughout, there is shown in FIG. 1 a block diagram illustrating an example communication system, generally designated 100, in accordance with an exemplary embodiment of the present invention. The communication system 100 enables communication between a first device 102 and a second device 104. The communication system 100 allows a user of a first device 102 to send a message 116 to the second device 104. For example, the system can be accessible on the first and second devices 102 and 104 via execution of a designated application 110 which can generate a graphical user interface (GUI) 106 on the first device 102 and a GUI 108 on the second device 104. The system can receive the message 114 from the first device 102 and transmit a message 118 to the second device 104.

The communication system 100 can include an interface 112 that receives data or messages from the first and second devices 102 and 104 over a network 114. The interface 112 can receive a communication request from the first device 102 to send a message to the second device 104. The communication request can be processed by a communication engine 120.

The communication engine 120 can receive location data 124 (e.g., GPS information) from a mapping module 122. The location data 124 can correspond to a location of the first device 102. When the first device 102 is located in a first vehicle, the location data 124 can correspond to the location of the first vehicle. The location data 124 can correspond to a location of the second device 104. When the second device 104 is located in a second vehicle, the location data 124 can correspond to the location of the second vehicle. The communication engine 120 can determine distance between the first and second vehicles. The communication engine 120 can compare the distance between the first and second vehicles to a threshold value. The communication engine 120 can allow the first device 102 to send a message to the second device 104 if the distance between the first and second vehicles is less than the threshold value. In some examples, the threshold value is about 10 feet, about 100 feet, about 1,000 feet, about 2,500 feet, about 5,000 feet, about 1 mile, about 5 miles, or less than 10 miles. The communication engine 120 can prevent communication between the first and second devices 102 and 104 if the distance between the first and second vehicles exceeds the threshold value.

In some examples, the first device 102 can initiate an interaction such as message or data transfer with the second device 104 when the distance between the first and second vehicles is less than the threshold value. The first and second devices 102 and 104 can continue to communicate as the first and second vehicles move relative to each other even if the distance between the vehicles exceeds the threshold value. In some examples, the communication engine 120 includes a first threshold value and a second threshold value that is greater than the first threshold value. The first device 102 can initiate the interaction with the second device 104 if the distance between the first and second vehicles is less than the first threshold value. The first and second devices 102 and 104 can continue to communicate as the first and second vehicles move relative to each other until the distance between the first and second vehicles is equal to or exceeds the second threshold value. In other examples, the first and second devices 102 and 104 can continue to communicate as the first and second vehicles move relative to each other for a select time period. The time period may be about 1 minute, about 5 minutes, about 10 minutes, about 15 minutes, about 30 minutes, about 1 hour, about 2 hours, about 5 hours, about 12 hours, or about 1 day.

The mapping module 122 can include map data 126. The map data 126 can include information about a throughway on which the first device 102, and therefore the first vehicle, is travelling. The throughway can be a road, river, etc. When the throughway is a road, the map data 126 can include the number of lanes in the road. The location data 124 can include the lane in which each of the first and second devices are travelling.

The communication system 100 can transmit the location data 124 of the first and second devices 102 and 104 to the first device 102 and the application 110 can display the positions of the first and second devices 102 and 104 of the GUI 106. The application 110 can display the first device 102 as a first icon and the second device 104 as a second icon different from the first icon. The first and second icons may be images of the first and second vehicles. The user of the first device 102 can select the second device 104 on the GUI 106 so as to view information about the second vehicle or to send a message to the second device 104. Selecting the second device 104 can include clicking or tapping the second icon.

The communication engine 120 can receive data 128 from a database 130 of the communication system 100. The data 128 can include insurance information 132, vehicle information 134, payment information 136, user information 138, deliverable messages 140, etc. The vehicle information 134 can include a vehicle make, model, and year. The vehicle information 134 can include an image of the vehicle. The vehicle information 134 can also include manufacturer trim packages or other after market parts that are installed on the vehicle. Each user of the communication system 100 can upload their desired information to the database through the application 110. The user can select what information is available to other users. Some information (e.g., vehicle make and model) can be publicly available. Other information (e.g., insurance information) may be private and require authorization for sharing. The user information 138 can include user name, address, driver license number, image of the user, etc.

The communication system 100 allows vehicle driver and passengers to message users in other vehicles while on the road. Some users may attempt to send a message to another user that is critical of another user's vehicle operation or driving. The database 130 can include a catalog of deliverable messages 140 that are more diplomatic than phrases typed in a fit of road rage. The communication engine 120 can receive and analyze the message 116 from the first device 102. The communication engine 120 can select the deliverable message 140 based on the analyzed content of the message 116. The message 118 delivered to the second device 104 can include the deliverable message 140.

The communication engine 120 can receive data 142 from a second database 144. Data 142 can include information pertaining to vehicle registration 146. The second database 144 can store data from a state motor vehicle agency database. The second database 144 may be periodically updated so as to include current registration information.

The communication system 100 may prompt the user of the first and second device 102 and 104 to select whether they are a driver or a passenger of the vehicle. The communication system 100 can limit a type of user input if a user selects that they are the driver. For example, the application can limit the user input to voice input if the user selects that they are the driver.

A user can have one or more vehicles associated with their account. For example, a user may have a first vehicle and a second vehicle. The application can allow the user to select which vehicle they are in.

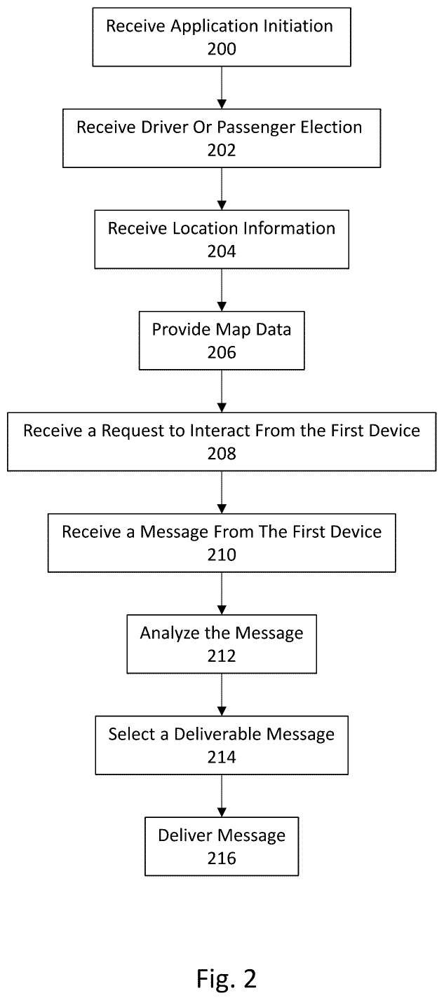

FIG. 2 is a flow chart illustrating an example method of facilitating an interaction between the first device 102 to the second device 104. The communication system 100 can receive an indication that the application 110 was launched on the first device 102 at step 200. The user of the first device 102 can select whether they are the passenger or the driver of the first vehicle in response to a prompt displayed on the GUI 106 at step 204. The communication system 100 can receive location information from the first device 102 at step 204. The system can also receive location information from any second device 104 within the vicinity of the first device 102 at step 204.

The communication system 100 can provide map data 206 to the first device 102 at step 206. The map data can include a road map of the area around the first device 102. The map data can include the location of first and second devices 102 and 104. The GUI can display the location of the first and second devices 102 and 104.

The communication system 100 can receive a request from a user to interact with the second device 104 at step 216. The user of the first device 102 may select the second device 104 on the GUI 106. The user of the first device 102 may elect to send a message second device 104. The interface 112 may receive the message 116 over the network 114 from the first device 102. The communication engine 120 receive the message 116 at step 210.

The communication engine 120 can analyze the substance of the message 116 at step 212. Analyzing the message 212 can include analyzing the text of a message. In some examples, analyzing the message 212 includes converting a voice message to text and analyzing the text of the message 116. The communication engine 120 can select a deliverable message 140 from the database 130 that corresponds to the analyzed message at step 214.

The communication system 100 can transmit the deliverable message 140 the second device 104 as message 118 over the network 114 at step 216. In some examples, the message 118 is delivered to the second device 104 in real time. In other examples, such as when the user of the second device 104 is a driver of the vehicle, the message may be delivered to the second device when the vehicle is stationary.

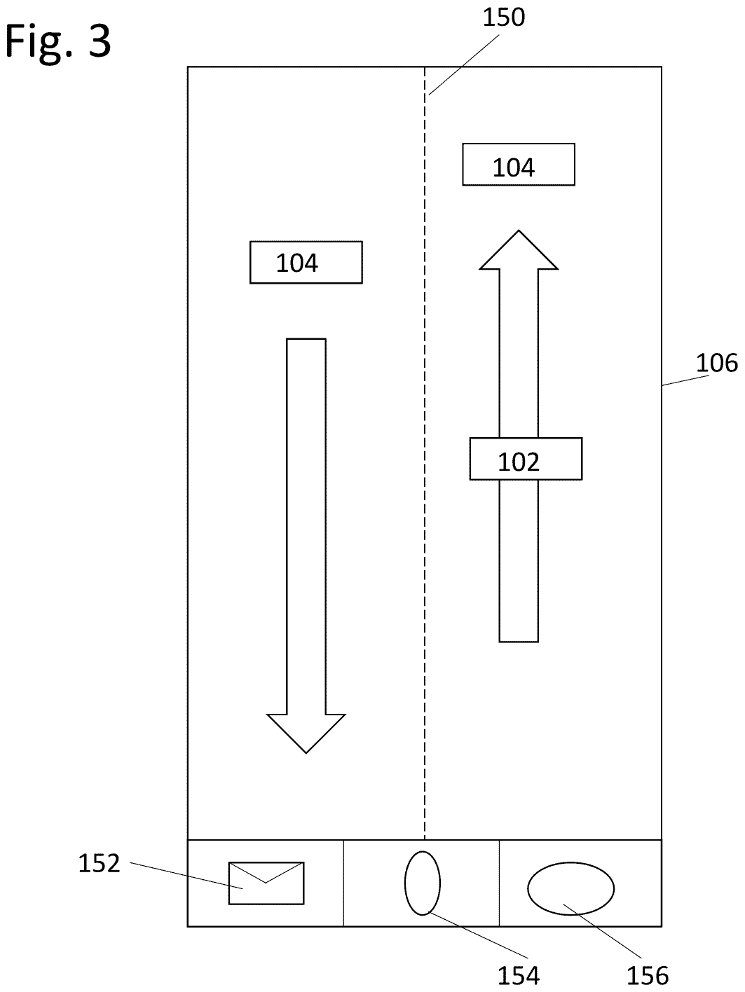

FIG. 3 is an example screenshot illustrating the first device 102 executing the application 110. A user may launch the application 110 specific to a network service on the first device 102. The GUI 106 can be generated on the first device 102 in response to launching the application 110. The GUI 106 can display the location of the first device 102. The first device 102 may be displayed at or close to the current location of the first device 102. The GUI 106 can display a first indicia representative of the first device 102. The first indicia can be a selected shape, drawing, or image. The image may be an image of the first vehicle.

The GUI 106 may display a map of the road on which the first device 102 is travelling. The GUI 106 can display each lane of the road. The GUI can display one or more dividing lines 150 that separate the road into lanes. The GUI can display a plurality of second devices 104 that are within the vicinity of the first device 102. The first device 102 can interact with any one of the plurality of second devices 104 via the communication network 100.

A GUI 106 that displays each lane of a road can help a user identify which vehicle the second device 104 is in so as to correctly select the second device that the user of the first device 102 would like to interact with. The communication system 100 can allow the first device 102 to send a message to a single one of the plurality of second devices 104. The communication system 100 can also allow a user to send a burst message to any of the second devices 104 that are in the same lane of the road as the first device 102. The user of the first device 102 can send a message to any of the second devices that are travelling in the same direction on the road as the first device 102. The communication system 100 can also allow the user of the first device 102 to send a message to all of the second devices 104 within the vicinity of the first device 102.

The GUI 106 can include a first icon 152 for sending a message. The first icon 152 can be an image of an envelope or another shape. The first device 152 can send a message when the first icon 152 is selected. The user can select whether to send a message to a single second device 104 or a plurality of second devices 104 once the first icon 152 is selected.

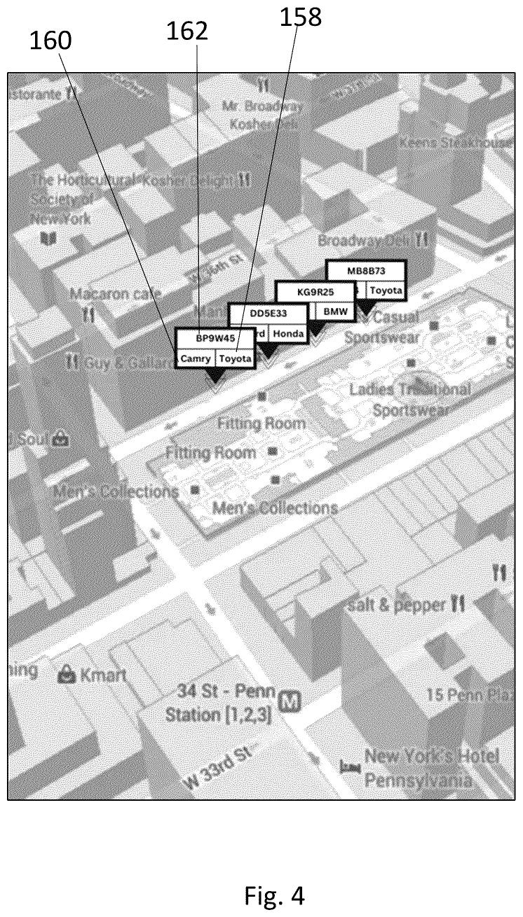

The GUI 106 may display identifying information for each of the plurality of second devices 104. As shown in FIG. 4, for example, the identifying information can include a make 158, model 160, and license plate number 162.

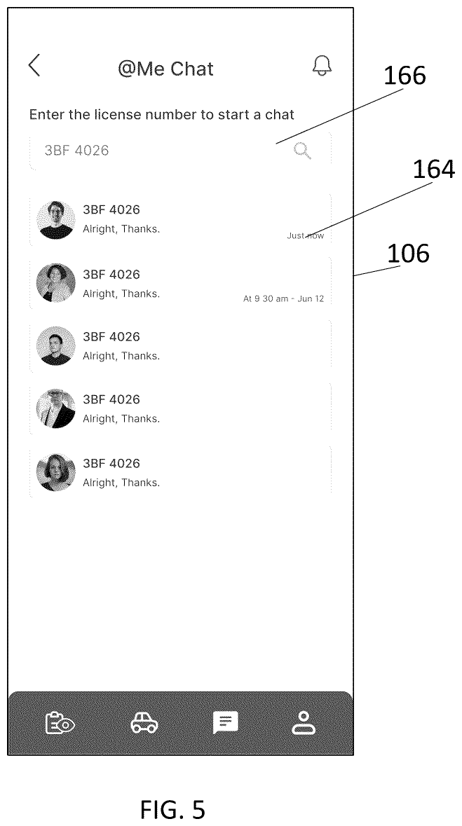

Referring to FIG. 5, the GUI 106 may display a list of nearby vehicles when the first icon 152 is selected. The GUI may display a status indicator 164 to indicate whether the user of the vehicle is logged into the application. The status indicator 164 may include a first appearance if the second device is available for live chat and a second appearance different from the first appearance if the second device is not available for live chat. The GUI 106 may display a search bar 166 that allows users to search for other vehicles. The user may search by entering a license plate number or driver's license number. The user of the first device 102 may send a message to another user by selecting the desired second user.

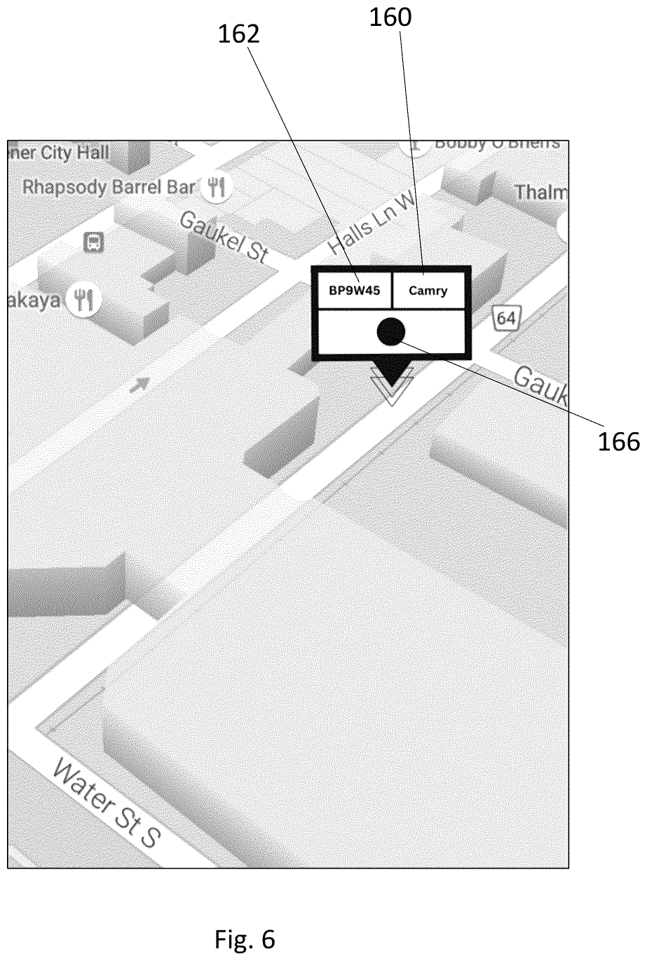

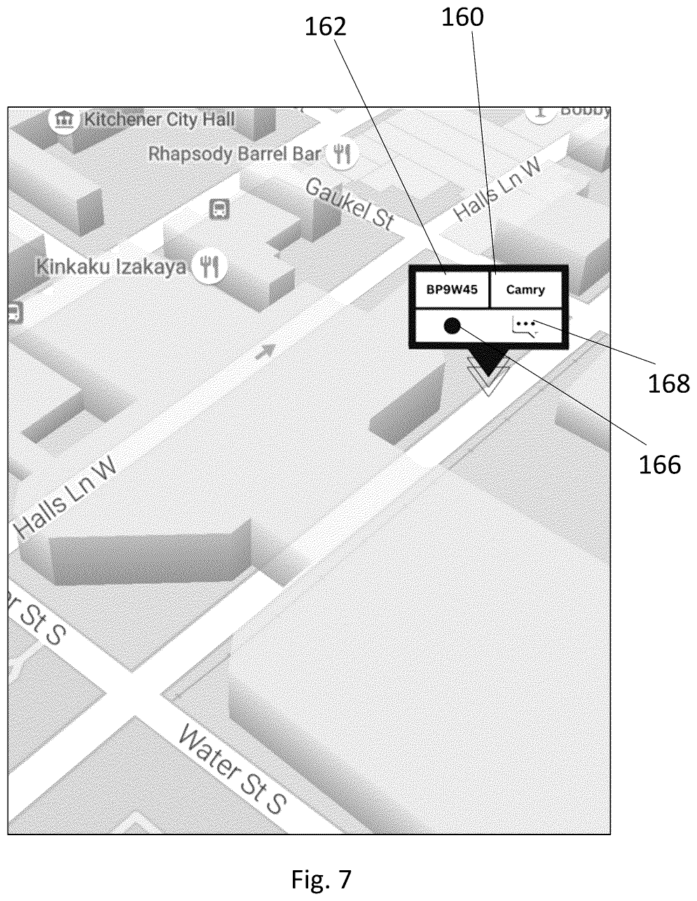

The GUI 106 may display different message options for a driver and a passenger. Referring to FIG. 6, a driver may only be able to select a voice message icon 166 corresponding to a voice message. The driver may be limited to hands free messaging while the vehicle is moving. Referring to FIG. 7, a passenger may have the option of selecting the voice message icon 166 or a writing icon 168 corresponding to a text message. The passenger may be able to send written messages when the vehicle is moving.

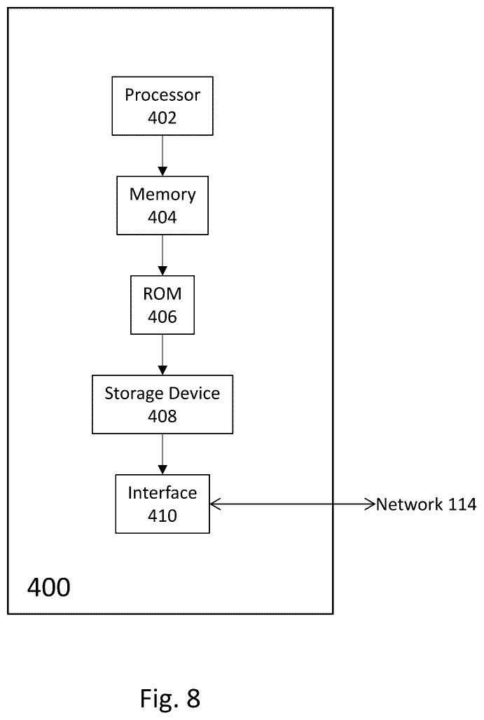

FIG. 8 is a block diagram illustrating a computer system 400 upon which examples described herein may be implemented. In some examples, the computer system 400 can be implemented on a server or combination of servers. For example, the computer system 400 may be implemented as part of a network service for providing communication between one or more devices. The communication system 100 of FIG. 1 may be implemented using the computer system 400. The communication system 100 may also be implemented using a combination of multiple computer systems 400.

The computer system 400 can include a processor, memory 404, read only memory or ROM 406, a storage device 408, and an interface 408. The processor 402 can process information stored in the memory 404, such as provided by a random-access memory (RAM) or other dynamic storage device, for storing information and instructions which are executable by the processor 402. The memory 404 can be a non-transitory computer readable storage medium. The memory 404 can store temporary variables or other intermediate information during execution of instructions to be executed by the processor 402. The computer system 400 may also include the ROM 406 or similar static storage device for storing instructions and information for the processor 402. A storage device 408, such as a magnetic disk or optical disk, is provided for storing information and instructions.

The interface 410 enables the computer system 400 to communicate with one or more networks 114 such as a cellular network through the use of a network link. The network link may be wired or wireless. Using the network link, the computer system 400 can communicate with one or more computing devices, and one or more servers. In accordance with examples, the computer system 400 receives location data from computing devices of users of the first and second devices. The executable instructions stored in the memory 404 are executed by the processor 402 so as to send the location data to the first device to allow the first device to interact with the second device as described in connection with FIG. 107. The processor 402 can perform operations so as to send a message from the first device to the second device over the at least one network 114 via the interface 410. The processor 510 is configured with software and/or other logic to perform the one or more steps, processes, and other functions as described in connection with FIGS. 1-7.

The computer system 400 described in this application implements the techniques described herein. According to one example, those techniques are performed by the computer system 400 in response to the processor 402 executing one or more sequences of one or more instructions contained in the memory 404. Such instructions may be read into the memory 404 from another machine-readable medium, such as the storage device 408. The processor 402, upon execution of the sequences of instructions contained in the memory 404, performs the process steps described herein. In alternative implementations, hard-wired circuitry may be used in place of or in combination with software instructions to implement examples described herein. Thus, the examples described are not limited to any specific combination of hardware circuitry and software.

The examples described herein may be implemented on a mobile computing device. In one example, a mobile computing device may correspond to, for example, a cellular communication device (e.g., feature phone, smartphone etc.) that is capable of telephony, messaging, and/or data services. Alternatively, a mobile computing device can correspond to, for example, a tablet or wearable computing device. Still further, a mobile computing device can be distributed amongst multiple portable devices of drivers, and requesting users.

A mobile computing device can include a processor, memory, a display device such as a touch-sensitive display device, one or more communication sub-systems (including wireless communication sub-systems), input mechanisms (e.g., an input mechanism can include or be part of the touch-sensitive display device), and one or more location detection mechanisms (e.g., a GPS component). In one example, at least one of the communication sub-systems sends and receives cellular data over data channels and voice channels.

In one embodiment, the communication system 100 includes one or more computers having one or more processors and memory (e.g., one or more nonvolatile storage devices). In some embodiments, memory or computer readable storage medium of memory stores programs, modules and data structures, or a subset thereof for a processor to control and run the various systems and methods disclosed herein. In one embodiment, a non-transitory computer readable storage medium having stored thereon computer-executable instructions which, when executed by a processor, perform one or more of the methods disclosed herein.

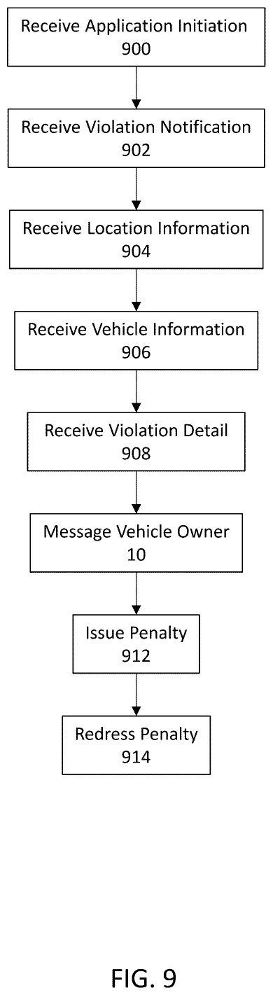

FIG. 9 is a flow chart illustrating an example method of facilitating an interaction between the first device 102 to the second device 104. The communication system 100 can receive an indication that an application 1010 was launched on the first device 102 at step 900. The application 1010 can be the same as application 110 other than the differences described herein. For example, the communication system 100 of FIG. 1 can include the application 1010. The user of the first device 102 may observe a vehicle parking violation. The user of the first device 102 can then report the parking violation related to a vehicle at step 902 via the application 1010. The user of the first device 102 can input information regarding the vehicle information and the parking violation. For example, the user of the first device 102 can input the location information regarding the parking violation at step 904. The location information may be automatically input based on the location of the first device 102. In other examples, the user of the first device 102 inputs the location on a map displayed on the GUI 106. The communication system 100 can determine an appropriate enforcement agency to notify about the parking violation based on the location of the parking violation. For example, the enforcement agency may be a parking authority, municipal police department, private entity, etc. The communication system 100 can send a request to a tow truck company to remove the vehicle based on the location of the parking violation.

The communication system 100 can receive vehicle information at step 906. The vehicle information can include a make, model, color, or license plate number of the vehicle. The vehicle information can include a photograph or video capture of the vehicle showing the parking violation. The communication system 100 can require submission of a photo or video of the vehicle by the user of the first device 102 to confirm the parking violation. The communication system 100 queries at least one of the database 130 and the second database 144 to determine if the parking violation is a first offense, second offense, third offense, etc. The offense number can be a factor in determining whether the communication system 100 sends the request to the tow company. In some examples, only the number of unresolved (e.g., fine issued but unpaid) parking violations are a factor in whether to send the tow request. In other examples, the number of parking violations, whether resolved or unresolved, is a factor in whether to send the tow request.

The communication system 100 can receive detailed information about the parking violation at step 908. The communication system 100 can receive the detailed information from the application 1010 on the user device 102. The violation detail can include information about the type of parking violation such as the vehicle blocking the bike or bus lane, blocking a driveway, blocking other vehicles into a parking spot, parking obstruction, parking in disability zone, blocking property, or restricting traffic. The type of parking violation (e.g., blocking a vehicle, parked in a no-parking zone, etc.) can be a factor in determining whether the communication system 100 sends the request to the tow company.

The communication system 100 can determine the vehicle owner at step 910. The communication system 100 can determine if the vehicle owner is a registered user of the communication system 100. The communication system 100 can send a message to the vehicle owner about the parking violation if the vehicle owner is a registered user of the communication system. The communication system 100 may provide a grace period for the vehicle owner to rectify the parking violation by moving the vehicle before issuing a penalty. The grace period may be 2 minutes, 5 minutes, 10 minutes, 15 minutes, 20 minutes, 30 minutes, 45 minutes, or 1 hour. The communication system 100 can facilitate communication between the user of the first device 102 and the owner of the vehicle. The owner of the vehicle can be the user of the second device 104. The first device 102 can send a message regarding the parking violation to the second device 104. The first device 102 can send the message before reporting the parking violation. The first device 102 can notify the second device 104 of the parking violation. The vehicle owner can rectify the parking violation in response to receive the message from the first device 102. The vehicle owner may rectify the parking violation by moving their car, paying for additional parking meter time, etc.

The communication system 100 can issue a penalty at step 912. In some examples, the penalty is a monetary fine. In other examples, the penalty is a physical impairment to the vehicle such as a wheel clamp lock, parking boot, or windshield obstruction device such as a Barnacle. In still other examples, the penalty can be a request to a tow company to remove the vehicle.

The communication system 100 can redress the issued penalty at step 914. The vehicle owner can pay the penalty via the application 1010 on the second device 104. The vehicle owner can challenge the penalty via the application 1010. For example, the vehicle owner can challenge that the parking violation occurred, that the vehicle is not theirs, that there is insufficient evidence of the violation, that the penalty is too extreme, etc. The communication system 100 can determine whether the penalty was properly issued in response to receiving the challenge. The owner of the vehicle may have the option to pay the penalty if the communication system 100 determines that the penalty was properly issued. The communication system 100 can record that the penalty has been redressed once the payment is received. Alternatively, the communication system 100 can delete the penalty if the vehicle owner successfully challenges the parking violation.

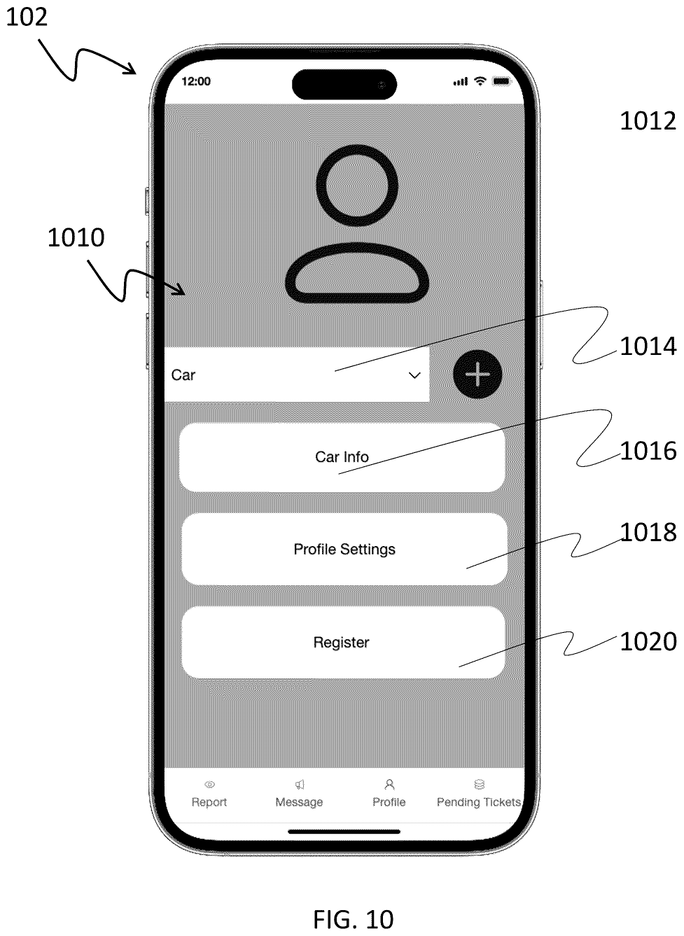

FIG. 10 is a screenshot of an application 1010 displayed on the first device 102. The user of the first device 102 can register their vehicle in the application. The application 1010 can include an input 1014 where the user can select the type of vehicle. The input 1014 can be a drop-down menu, a list of vehicles with a radio button to select, etc. The application 1010 can include a vehicle information input 1016. The user can input the make, model, insurance information, license plate number, or driver information into the vehicle information input 1016. The application 1010 can include a profile settings input 1018. The profile settings can include username, payment information, election of whether to receive messages from other users, notification settings, etc. The user can finalize their registration by interacting with the register input 1020.

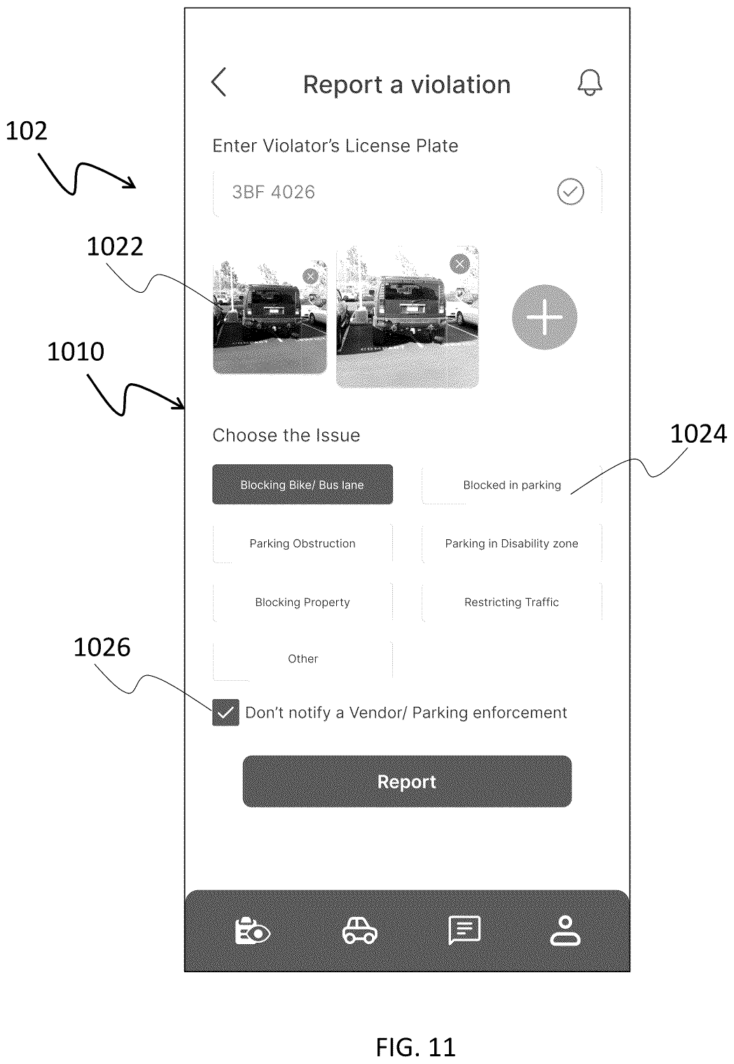

FIG. 11 is a screenshot of the application 1010 on the first user device 102. The user can input the license plate number of a vehicle committing a parking violation into the application 1010. The user can select the type of parking violation by interacting (e.g., toggling, tapping, swiping, etc.) one or more inputs 1024. For example, the parking violation can be blocking the bike/bus lane, blocked in parking, parking obstruction, parking in a disability zone, blocking property, or restricting traffic. The application 1010 can include a plurality of inputs 1024. Each input can be indicative of a different type of parking violation. The user can also input the type of parking violation in a free form style by selecting “other”. The user can transmit photo or video evidence of the parking violation by selecting an image input 1022. In some examples, the image input 1022 is displayed as a camera icon. The application 1010 may access the user's photos or camera in response to the user selecting the image input 1022. The user can send the parking violation information to the second user device 104 by interacting (e.g., swiping or pressing) the send button. The user can select whether to send the parking violation information to the second user device 104 or to parking enforcement authority. For example, the application 1010 can include a selector 1026 that allows the user of the first device 102 to select whether the parking violation is reported to authorities. The parking violation can be sent to the second user device 104 as an informative parking tip rather than to an enforcement body so as to notify the vehicle owner of the parking violation without involving authorities.

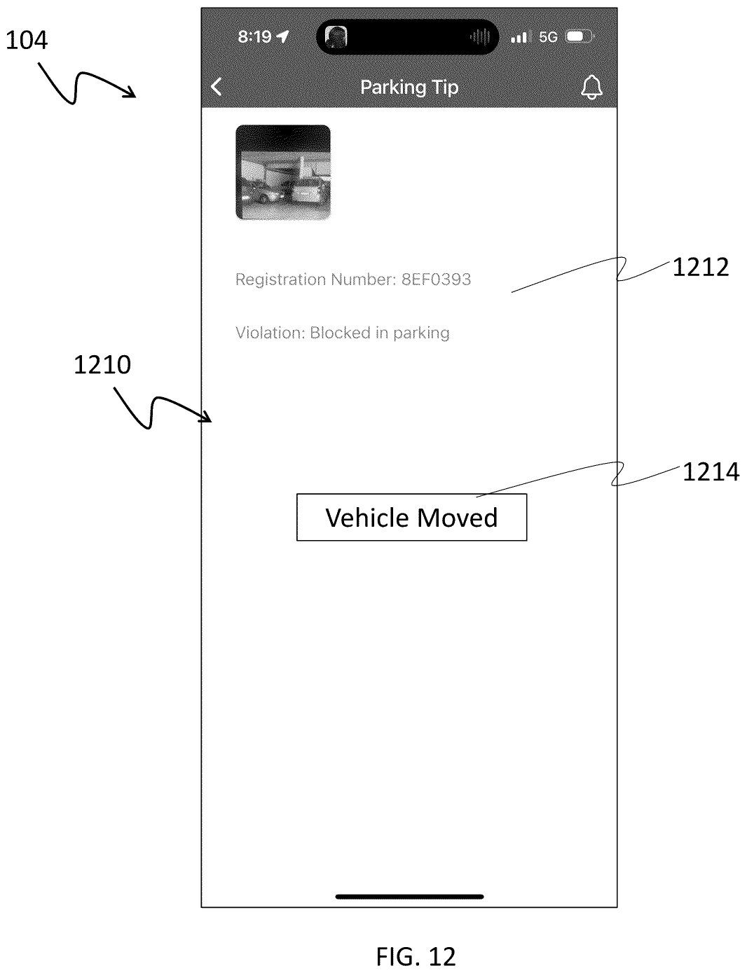

FIG. 12 is a screenshot of an application 1210 displayed on the GUI 108 of the second device 104. The application 1210 displays a notification 1212 that a parking violation notification or tip has been received regarding the user's vehicle. The user can provide notification to the communication system 100 that the vehicle has been moved. For example, the user can swipe, toggle, or press an indicator 1214 indicating that the vehicle has been moved. The application 1210 can display information about the type of parking violation such as expired parking meter, blocking in parking, etc.

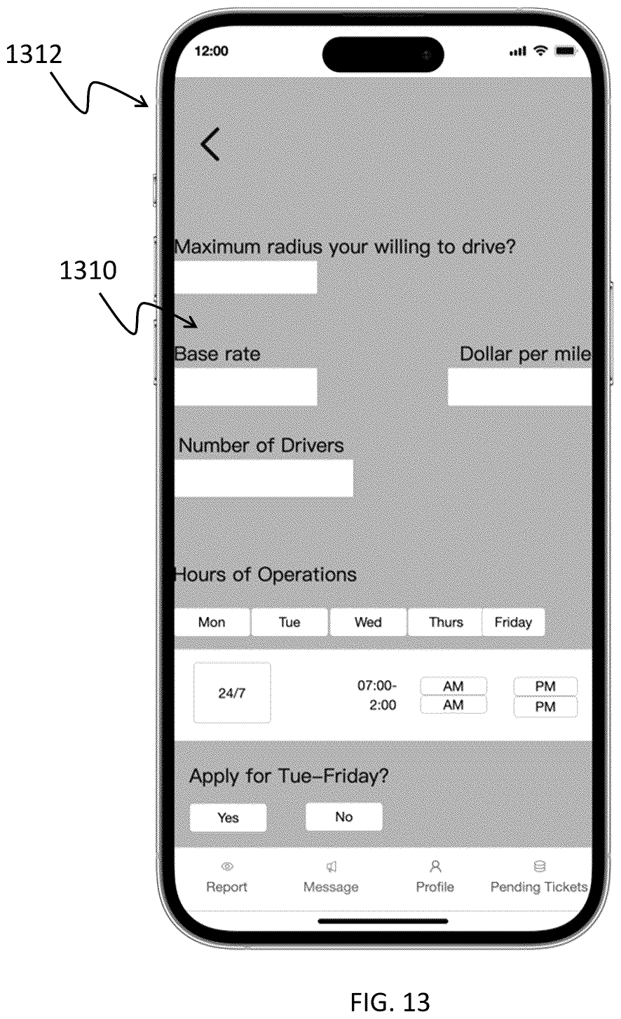

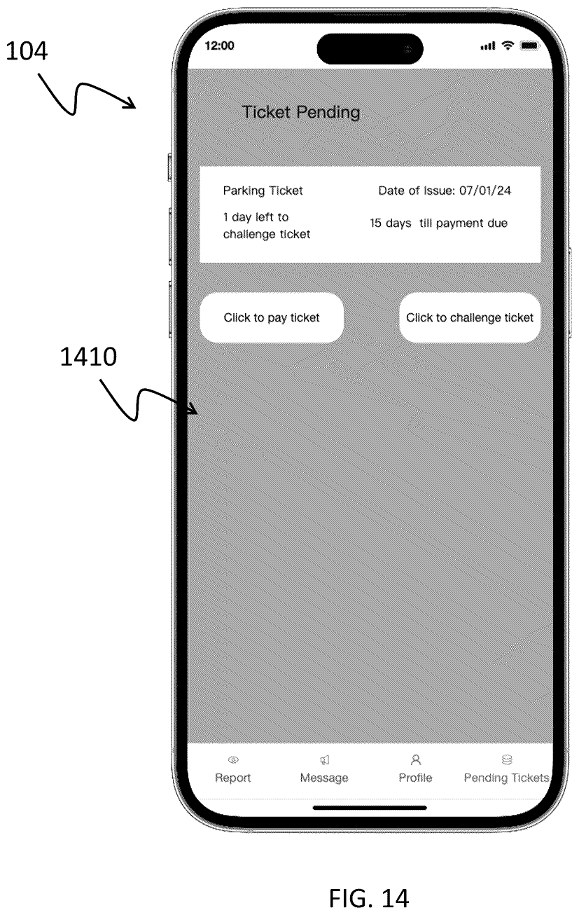

FIG. 13 is a screenshot of an application 1310 displayed on a GUI of a third device 1312. The third device may be the same as, or similar to, the first device 102. The user of the third device 1312 may be a towing company. The application 1310 can allow towing companies to input their preferences for interaction with the communication system 100. For example, the towing company can input their location, work radius, base rate, fleet size, number of drivers, required pay per mile of towing, and their hours of operation. The communication system 100 may send a towing request to the towing company when there is a need for a tow that fits the towing company criteria. The communication system 100 may send the captured information received from the first device 102 to the third device 1312 in response to receiving the captured information from the first device 102. The communication system 100 may send the captured information to a local police department, parking authority, or towing company.

FIG. 16 is a screenshot of an application 1410 displayed on the GUI 108 of the second device 104. The application 1410 displays information about a parking violation reported by a user of the first device 102. The notification can include information about the date of the violation, the location, and the number of days until payment is due. The user of the second device 104 can elect to pay the citation via the application 1410 by selecting the appropriate option. Alternatively, the user can elect to challenge the citation by selecting the appropriate option. The citation can be dismissed upon a successful challenge. In some examples, the communication system 100 sends data to at least one of the database 130 and the second database 144 regarding the citation. For example, the communication system 100 can send the date of the parking violation, the type of parking violation, and the fine amount to the at least one of the database 130 and the second database 144.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

I/We claim:

1. A communication system comprising:
a network communication interface to communicate over at least one network with a computing device of a first vehicle, and a computing device of a second vehicle;
one or more processors; and
one or more memory resources storing instructions that, when executed by the one or more processors, cause the communication system to:
receive, over the one or more networks, location data from each of the first vehicle and the second vehicle;
transmit, over the at least one network, a position signal to the computing device of the first vehicle, the position signal causing the computing device of the first vehicle to display a position of the second vehicle on a graphical user interface (GUI) generated by an application executing on the computing device of the first vehicle; and
transmit, over the at least one network, a message from the computing device of the first vehicle to the computing device of the second vehicle.

2. The communication system of claim 1, wherein the executed instructions further cause the communication system to:
determine if the position of the first vehicle relative to the second vehicle is below a predetermined threshold based, at least in part, on the position data of the first and second vehicles.

3. The communication system of claim 1, wherein the executed instructions further cause the communication system to:
transmit, over the at least one network, a vehicle information signal to the computing device of the first vehicle, the vehicle information signal causing the computing device of the first vehicle to display vehicle information about the second vehicle on the GUI of the computing device of the first vehicle.

4. The communication system of claim 3, wherein the vehicle information includes at least one of a make, a model, and a color of the second vehicle.

5. The communication system of claim 3, wherein the vehicle information includes an image of the second vehicle.

6. The communication system of claim 3, wherein the vehicle information includes an image of a driver of the second vehicle.

7. The communication system of claim 3, wherein the executed instructions further cause the communication system to:
display, on the GUI of the computing device of the first vehicle, a map including a road on which the first vehicle is located.

8. The communication system of claim 7, wherein the road includes a plurality of lanes and the map displays the plurality of lanes.

9. The communication system of claim 8, wherein the second vehicle is one of a plurality of second vehicles,
wherein a first one of the plurality of second vehicles and the first vehicle are located in a first one of the plurality of lanes, and a second one of the plurality of second vehicles is in a second one of the plurality of lanes different from the first one of the plurality of lanes, and
wherein the executed instructions further cause the communication system to transmit, over the at least one network, a message from the computing device of the first vehicle to a computing device of each of the first and second ones of the plurality of second vehicles in response to selection of a burst message on the computing device of the first vehicle.

10. The communication system of claim 9, wherein the executed instructions further cause the communication system to transmit, over the at least one network, a message from the computing device of the first vehicle to the computing device of the first one of the plurality second vehicles in response to selection of a lane message on the computing device of the first vehicle.

11. The communication system of claim 3, wherein the executed instructions further cause the communication system to:
provide, on the GUI on the computing device of the first vehicle, at least one messaging icon; and
receive a user selection of one of the at least one messaging icons.

12. The communication system of claim 11, wherein the at least one messaging icon includes a first icon for sending a voice message.

13. The communication system of claim 12, wherein the at least one messaging icon includes a second icon for sending a text message.

14. The communication system of claim 12, wherein the executed instructions further cause the communication system to:
convert the voice message to a text message.

15. The communication system of claim 11, wherein the at least one icon includes a first appearance before the message is sent and a second appearance after the message is sent, the second appearance different from the first appearance.

16. The communication system of claim 12, wherein the executed instructions further cause the communication system to:
analyze the text message;
compare the text message to a database of deliverable messages and select one of the deliverable messages from the database; and
transmit, over the at least one network, the deliverable message from the database to the computing device of the second vehicle.

17. The communication system of claim 3, wherein the second vehicle comprises a first one of a plurality of second vehicles and the executed instructions further cause the communication system to:
receive, over the one or more networks, location data of a second one of the plurality of second vehicles;
determine the position of the second one of the plurality of second vehicles relative to the first vehicle; and
transmit, over the at least one network, a second position signal to the computing device of the first vehicle, the second position signal causing the computing device of the first vehicle to display a position of the second one of the plurality of second vehicles on the GUI.

18. The communication system of claim 17, wherein the executed instructions further cause the communication system to:
transmit, over the at least one network, a second vehicle information signal to the computing device of the first vehicle, the second vehicle information signal causing the computing device of the first vehicle to display vehicle information about the second one of the plurality of second vehicles on the GUI.

19. The communication system of claim 18, wherein the GUI simultaneously displays the vehicle information of the first and second ones of the plurality of second vehicles.

20. The communication system of claim 1, wherein the executed instructions further cause the communication system to access, over the at least one network, a database that includes vehicle registration and insurance information for the first vehicle.
